(19) United States
(12) Patent Application Publication
(10) Pub. No.: US 2014/0126087 A1
(43) Pub. Date: May 8, 2014

(54) ELECTRIC POWER CONVERSION APPARATUS, CURRENT-CARRYING DEVICE THAT CARRIES AC POWER, AND METHOD OF MANUFACTURING CURRENT-CARRYING DEVICE THAT CARRIES AC POWER

(71) Applicant: Satoshi HIROSE, Seto-shi (JP)

(72) Inventor: Satoshi HIROSE, Seto-shi (JP)

(73) Assignee: TOYOTA JIDOSHA KABUSHIKI KAISHA, Toyota-shi (JP)

(21) Appl. No.: 14/069,593

(22) Filed: Nov. 1, 2013

(30) Foreign Application Priority Data
Nov. 5, 2012 (JP) 2012-243620

(51) Int. Cl. H02H 7/122; H01H 69/02

(52) U.S. Cl. CPC H02H 7/122; H01H 69/02
USPC 361/18; 29/623

(57) ABSTRACT

A current-carrying device that carries AC power, including: an adjacent portion in which the AC power is input from or output to an external device; and a fuse portion that is adjacent to the adjacent portion, in which a cross-sectional area of the fuse portion is smaller than that of the adjacent portion, and in which a magnetic flux density generated in the fuse portion is smaller than a magnetic flux density generated in the adjacent portion when a structure of the fuse portion is made identical with that of the adjacent portion.

### INCORPORATION BY REFERENCE

The disclosure of Japanese Patent Application No. 2012-243620 filed on Nov. 5, 2012 including the specification, drawings and abstract is incorporated herein by reference in its entirety.

### BACKGROUND OF THE INVENTION

1. Field of the Invention

The present invention relates to an electric power conversion apparatus, a current-carrying device, and a method of manufacturing the current-carrying device.

2. Description of Related Art

Some electric power conversion apparatuses such as an inverter and a converter include a fuse portion for interrupting a current-carrying path when an overcurrent flows through the current-carrying path. In the electric power conversion apparatus disclosed in Japanese Patent Application Publication No. 2012-29459 (JP 2012-29459 A), a power terminal of a semiconductor device is connected to a bus bar. In the electric power conversion apparatus described above, a fuse portion is formed in the bus bar. A cross-sectional area of the fuse portion is determined to be smaller than that of the other portion in the bus bar. Therefore, when the overcurrent flows through the current-carrying path, the fuse portion blows, and the current-carrying path is interrupted.

In the electric power conversion apparatus disclosed in JP 2012-29459 A, the cross-sectional area of the fuse portion in the bus bar is smaller than that of the other portion in the bus bar. Thus, a large parasitic inductance occurs in the fuse portion, and an inductance of the current-carrying path increases. As a result, a surge voltage when the semiconductor device is turned on and off increases.

### SUMMARY OF THE INVENTION

The present invention provides a technique in which the current-carrying path can be interrupted when the overcurrent flows through the electric power conversion apparatus, and the inductance of the current-carrying path can be prevented from increasing.

An electric power conversion apparatus according a first aspect of the present invention includes: an electric power conversion portion that switches on and off a power device and converts between AC power and DC power; an adjacent portion that is connected to a terminal of the power device; and a fuse portion that is adjacent to the adjacent portion, in which a cross-sectional area of the fuse portion is smaller than that of the adjacent portion, and in which a magnetic flux density generated in the fuse portion is smaller than a magnetic flux density generated in the adjacent portion when a structure of the fuse portion is made identical with that of the adjacent portion.

A current-carrying device that carries AC power according a second aspect of the present invention includes: an adjacent portion in which the AC power is input from or output to an external device; and a fuse portion that is adjacent to the adjacent portion, in which a cross-sectional area of the fuse portion is smaller than that of the adjacent portion, and in which a magnetic flux density generated in the fuse portion is smaller than a magnetic flux density generated in the adjacent portion when a structure of the fuse portion is made identical with that of the adjacent portion.

A method of manufacturing a current-carrying device that carries AC power according a third aspect of the present invention includes: forming a cross-sectional area of a fuse portion that is adjacent to an adjacent portion to be smaller than that of the adjacent portion, the adjacent portion in which the AC power is input from or output to an external device; and forming an adjustment portion so that a magnetic flux density generated in the fuse portion to be smaller than a magnetic flux density generated in the adjacent portion when a structure of the fuse portion is made identical with that of the adjacent portion.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a cross-sectional view that shows a fuse portion of an electric power conversion apparatus according to a first embodiment of the present invention;

FIG. 2 is a cross-sectional view taken along the line II-II in FIG. 1;

FIG. 3 is a cross-sectional view taken along the line III-III in FIG. 1;

FIG. 4 is a cross-sectional view that shows the fuse portion of the electric power conversion apparatus according to a second embodiment of the present invention;

FIG. 5 is a cross-sectional view taken along the line V-V in FIG. 4;

FIG. 6 is a cross-sectional view taken along the line VI-VI in FIG. 4;

FIG. 7 is a cross-sectional view that shows the fuse portion of the electric power conversion apparatus according to a third embodiment of the present invention;

FIG. 8 is a cross-sectional view taken along the line VIII-VIII in FIG. 7;

FIG. 9 is a cross-sectional view that shows the other form of the fuse portion of the electric power conversion apparatus according to the third embodiment of the present invention; and

FIG. 10 is a circuit diagram that shows an overall structure of the electric power conversion apparatus.

### DETAILED DESCRIPTION OF EMBODIMENTS

In an electric power conversion apparatus according to the present invention, the surface area per unit length of a fuse portion is made to be larger than the surface area per unit length of a current-carrying path for an adjacent portion that is adjacent to the fuse portion.

In the electric power conversion apparatus described above, the surface area per unit length of the fuse portion is larger than the surface area per unit length of the current-carrying path for the adjacent portion that is adjacent to the fuse portion. Therefore, when the skin effect occurs, the density of the current flowing in a portion adjacent to a surface of the fuse portion can be reduced. Thus, a parasitic inductance that occurs in the fuse portion can be reduced in comparison with a case where a surface area per unit length of the fuse portion is the same as the surface area per unit length of the adjacent portion. Accordingly, an inductance of the current-carrying path can be reduced effectively.

In the electric power conversion apparatus according to the present invention, magnetic permeability of a material that is located on a surface of the fuse portion is made to be lower than the magnetic permeability of the material that is located on the surface of the adjacent portion.

When a power device is turned on and off, a state of the current-carrying path changes between the states in which the electric current flows through the current-carrying path or not. Therefore, much electric current flows in a surface layer portion of the current-carrying path due to a skin effect. In the electric power conversion apparatus described above, the magnetic permeability of the material that is located on the surface of the fuse portion is lower than the magnetic permeability of the material that is located on the surface of the adjacent portion that is adjacent to the fuse portion. Thus, the parasitic inductance that occurs in the fuse portion can be reduced effectively in comparison with a case where the magnetic permeability of the material that is located on the surface of the fuse portion is the same as the magnetic permeability of the material that is located on the surface of the adjacent portion. Accordingly, an inductance of the current-carrying path can be reduced.

### First Embodiment

An electric power conversion apparatus 40 of a first embodiment is a three-phase inverter. As shown in FIG. 10, the electric power conversion apparatus 40 includes upper arms 111, 113, and 115 and lower arms 112, 114, and 116. Upper ends of the upper arms 111, 113, and 115 are respectively connected to positive terminals of a DC power supply 52. Lower ends of the lower arms 112, 114, and 116 are respectively connected to negative terminals of the DC power supply 52. A lower end of the upper arm 111 and an upper end of the lower arm 112 are connected to each other in a connection portion 37. Similarly, a lower end of the upper arm 113 and an upper end of the lower arm 114 are connected to each other in a connection portion 38. A lower end of the upper arm 115 and an upper end of the lower arm 116 are connected to each other in a connection portion 39. The connection portions 37, 38, and 39 are respectively connected to input terminals for V-, U-, and W-phases of a motor 42.

Power devices 11, 13, and 15 are respectively provided in the upper arms 111, 113, and 115. Power devices 12, 14, and 16 are respectively provided in the lower arms 112, 114, and 116. In addition, freewheeling diodes 31 through 36 are respectively arranged in parallel with the power devices 11 through 16. A capacitor 50 is arranged in parallel with the devices in which the lower end of the upper arm 111 is connected to the upper end of the lower arm 112, in which the lower end of the upper arm 113 is connected to the upper end of the lower arm 114, and in which the lower end of the upper arm 115 is connected to the upper end of the lower arm 116.

The electric power conversion apparatus 40 switches on and off the power devices 11 through 16 to convert a direct current from the DC power supply 52 to a three-phase alternating current. The three-phase alternating current is supplied to the motor 42. When the electric power conversion apparatus 40 operates, the power device 11 of the upper arm 111 and the power device 12 of the lower arm 112 are alternately switched on and off. When the power device 11 is turned on, an electric current flows through the upper arm 111 from a positive terminal of the DC power supply 52 toward an input terminal for the V-phase of the motor 42. In other words, when the power device 11 is on, the electric current flows through the upper arm 111 from the upper side toward the lower side of FIG. 10. On the other hand, when the power device 11 is turned off, an electric current does not flow through the upper arm 111. In other words, when the electric power conversion apparatus 40 operates, a state where the electric current flows through the upper arm 111 and a state where the electric current does not flow through the upper arm 111 are alternately repeated. Therefore, a skin effect occurs in the upper arm 111 during the operation of the electric power conversion apparatus 40. The skin effect occurs at both of a fuse portion 21 and an adjacent portion 120 that are described below. The skin effect causes much electric current to flow in a section adjacent to a surface of the upper arm 111.

As shown in FIG. 10, fuse portions 21, 23, and 25 are respectively formed in the upper arms 111, 113, and 115. Fuse portions 22, 24, and 26 are respectively formed in the lower arms 112, 114, and 116. The fuse portions 21, 23, and 25 are respectively located on the side of the positive terminals of the DC power supply 52 with respect to the power devices 11, 13, and 15. The fuse portions 22, 24, and 26 are respectively located on the side of the negative terminals of the DC power supply 52 with respect to the power devices 12, 14, and 16.

In the case where an open failure or other failures of the power device 12 occurs, for example, the power device 11 of the upper arm 111 and the power device 12 of the lower arm 112 are simultaneously turned on. In this case, the upper arm 111 and the lower arm 112 short out, and an overcurrent flows through the upper arm 111. When the overcurrent flows through the upper arm 111, the fuse portion 21 blows. Similarly, when the overcurrent flows through the respective arms 112 through 116, the respective fuse portions 22 through 26 blow. The respective fuse portions 22 through 26 are designed in advance to blow when the overcurrent flows through. The blowout of the fuse portion 21 results in no current flowing through the arm 111. Similarly, the blowout of the respective fuse portions 22 through 26 results in no current flowing through the respective arms 112 through 116.

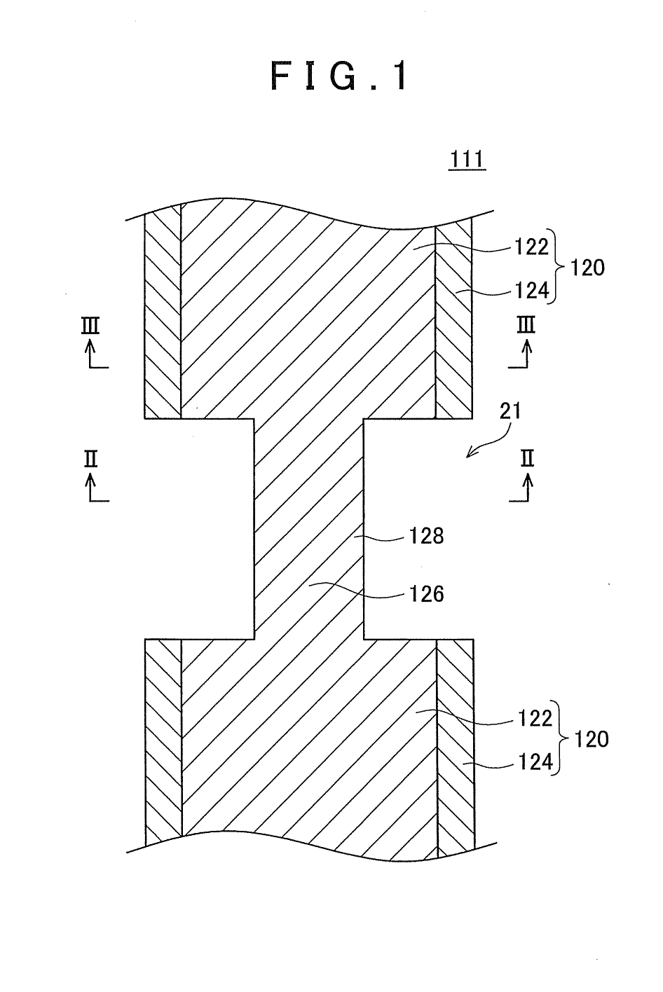

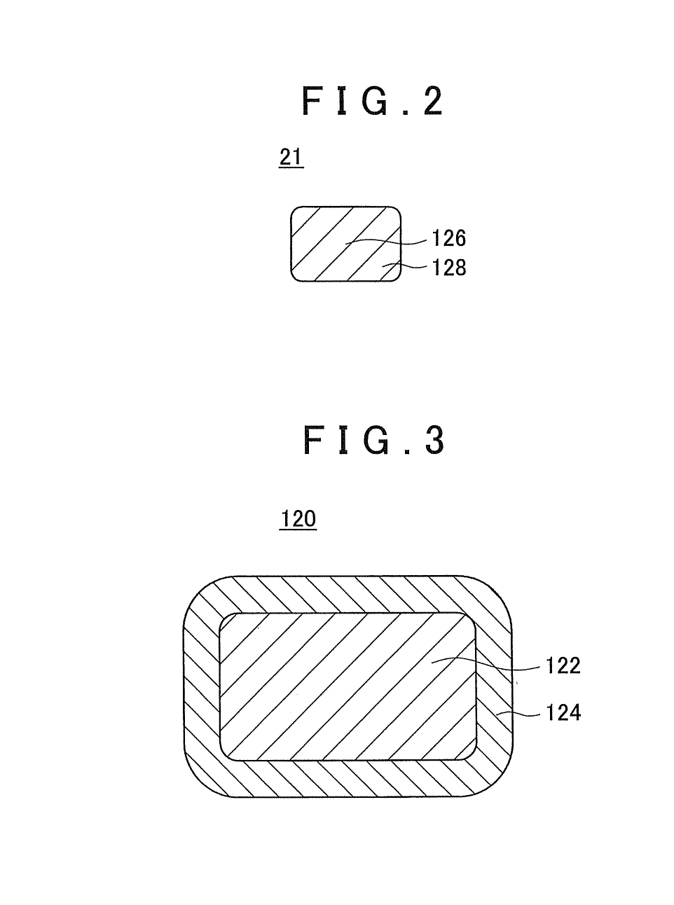

The structure of the fuse portion 21 will be described next. However, the structures of the fuse portions 22 through 26 are the same as that of the fuse portion 21, and therefore the descriptions are not repeated. As shown in FIG. 1, the fuse portion 21 is formed in the upper arm 111. In the description below, a portion of the upper arm 111 where the fuse portion 21 is not formed and that is adjacent to the fuse portion 21 is referred to as an adjacent portion 120. As shown in FIGS. 2 and 3, a cross-sectional area of the upper arm 111 at the fuse portion 21 is smaller than the cross-sectional area at the adjacent portion 120. As shown in FIG. 2, each portion of the fuse portion 21 of the present embodiment in cross-section is formed of the same material.

In the description of the present embodiment, a portion of the fuse portion 21 that is located on the surface of the upper arm 111 is referred to as a surface layer portion 128. In addition, a portion of the fuse portion 21 that is located inside the surface layer portion 128 is referred to as a deep layer portion 126. The surface layer portion 128 and the deep layer portion 126 of the fuse portion 21 are formed of a material that has electrical conductivity. As the material that forms the surface layer portion 128 and the deep layer portion 126 of the fuse portion 21, aluminum (Al) can be used, for example. In addition, the material that forms the surface layer portion 128 and the deep layer portion 126 of the fuse portion 21 may be copper (Cu).

The adjacent portion 120 includes a surface layer portion 124 as a portion that is located on the surface of the upper arm 111 and a deep layer portion 122 as a portion that is located inside the surface layer portion 124. The material that forms the deep layer portion 122 of the adjacent portion 120 is the same as the material that forms the surface layer portion 128 and the deep layer portion 126 of the fuse portion 21.

The surface layer portion 124 of the adjacent portion 120 is an Ni layer that is formed of nickel (Ni). The surface layer portion 124 (namely, Ni layer) can be formed with Ni plating, for example. Magnetic permeability of the material that forms the surface layer portion 128 of the fuse portion 21 (such as Al) is lower than the magnetic permeability of the material that forms the surface layer portion 124 of the adjacent portion 120 (such as Ni). Therefore, in the electric power conversion apparatus 40 of the present embodiment, the magnetic permeability of the surface layer portion 128 of the fuse portion 21 is lower than that of the surface layer portion 124 of the adjacent portion 120.

In the electric power conversion apparatus 40 of the present embodiment, the cross-sectional area of the fuse portion 21 is smaller than that of the adjacent portion 120. Therefore, when the overcurrent flows through the upper arm 111, the fuse portion 21 blows, and the passage of the electric current through the upper arm 111 can be interrupted.

The Ni layer (surface layer portion 124) is formed on the surface of the adjacent portion 120. Thus, when the adjacent portion 120 is soldered to another wire and the like, a joining force between the adjacent portion 120 and solder can be increased.

As described above, the skin effect occurs in the fuse portion 21 during the use of the electric power conversion apparatus 40. Therefore, much electric current flows in surface layer portion 128 of the fuse portion 21 in comparison with the deep layer portion 126. In the electric power conversion apparatus 40 of the present embodiment, the magnetic permeability of the material that forms the surface layer portion 128 of the fuse portion 21 is lower than the magnetic permeability of the material that forms the surface layer portion 124 of the adjacent portion 120. In other words, the magnetic permeability of the material that is located on the surface of the fuse portion 21 is lower than the magnetic permeability of the material that is located on the surface of the adjacent portion 120. Thus, the magnetic flux density generated in the fuse portion 21 can be decreased in comparison with a case where the magnetic permeability Of the material that is located on the surface of the fuse portion 21 is the same as the magnetic permeability of the material that is located on the surface of the adjacent portion 120. Accordingly, a parasitic inductance that occurs in the fuse portion 21 can be reduced, and an inductance of the upper arm 111 can be reduced. As a result, a surge voltage generated by turning on and off the power device 11 can be suppressed.

In this embodiment, if the Ni layer is formed on the surface of the fuse portion 21 to make the structure of the fuse portion 21 identical with that of the adjacent portion, the magnetic flux density generated in the fuse portion 21 increases in comparison with a case where the Ni layer is not formed on the surface of the fuse portion. In other words, the electric power conversion apparatus 40 of the present embodiment has the fuse portion 21 and the adjacent portion 120 with the identical structure, in which the magnetic flux density generated in the fuse portion 21 is decreased in comparison with a case where only the cross-sectional area of the fuse portion 21 is made to be smaller than that of the adjacent portion 120.

A method of manufacturing the fuse portion 21 and the adjacent portion 120 of the present embodiment will be described next. To manufacture the fuse portion 21 and the adjacent portion 120, an Al wire that has a length corresponding to the length of the upper arm 111 is used. First, the surface of the Al wire is plated with nickel to form the Ni layer thereon. Then, the surface of a portion of the Al wire formed with the Ni layer where the fuse portion 21 is formed is cut. The cross-sectional area of the upper arm 111 where the fuse portion 21 is formed is reduced through the cutting. In the cutting, the material is removed from the surface of the Al wire to a depth exceeding the depth of the Ni layer.

The portion of the upper arm 111 where the material is removed functions as the fuse portion 21. In addition, the portion of the upper arm 111 where the material is not removed and that is adjacent to the fuse portion 21 functions as the adjacent portion 120. In the adjacent portion 120, the portion of the Ni layer functions as the surface layer portion 124, and the portion of the Al wire functions as the deep layer portion 122. It should be noted that the method of removing the material of the portion which functions as the fuse portion 21 may be etching or other methods.

As another method of manufacturing the fuse portion 21 and the adjacent portion 120, the following method may be used. First, the material on the surface of the portion of the Al wire which functions as the fuse portion 21 is removed, and the cross-sectional area is reduced. The portion where the cross-sectional area is reduced functions as the fuse portion 21. Next, the surface of the portion of the Al wire where the material is not removed is plated with nickel to form the Ni layer thereon. The portion of the Al wire where the Ni layer is formed functions as the adjacent portion 120. In the adjacent portion 120, the portion of the Ni layer functions as the surface layer portion 124, and the portion of the Al wire functions as the deep layer portion 122.

### Second Embodiment

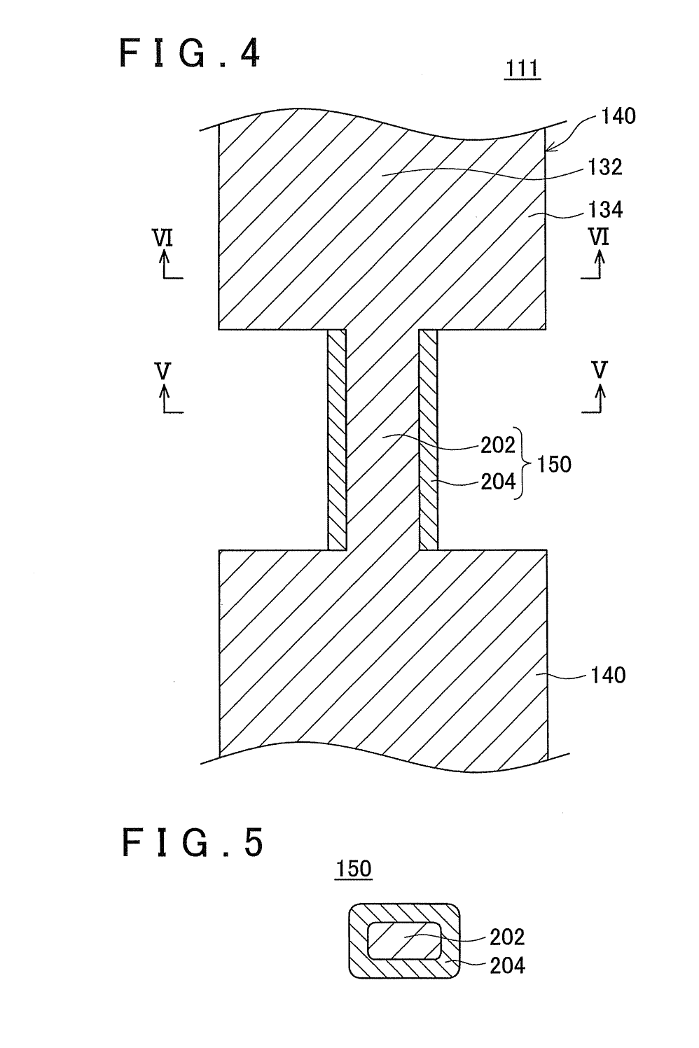

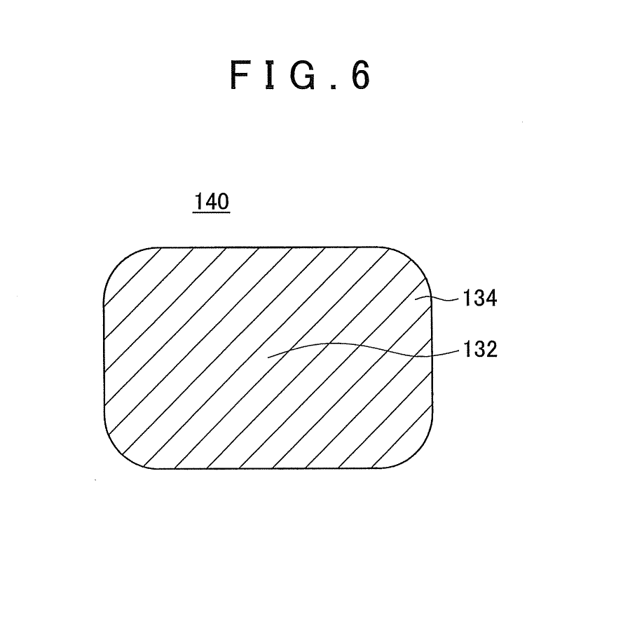

A fuse portion 150 of a second embodiment is formed in the upper arm 111 in the same manner as the fuse portion 21 of the first embodiment (FIG. 4). As shown in FIG. 5, the fuse portion 150 includes a surface layer portion 204 that is located on the surface of the upper arm 111 and a deep layer portion 202 that is located inside the surface layer portion 204. The material that forms the deep layer portion 202 of the fuse portion 150 is a material that has electrical conductivity. As the material that forms the deep layer portion 202 of the fuse portion 150, aluminum can be used, for example. The material that forms the surface layer portion 204 of the fuse portion 150 is a material that has electrical conductivity. In addition, the magnetic permeability of the material that forms the surface layer portion 204 of the fuse portion 150 is lower than the magnetic permeability of the material that forms a surface layer portion 134 of an adjacent portion 140 described below (such as Al). As the material that forms the surface layer portion 204 of the fuse portion 150, copper can be used, for example.

The adjacent portion 140 of the present embodiment is folioed of a single material in entire cross-section as shown in FIG. 6. In the description of the present embodiment, a portion of the adjacent portion 140 that is located on a surface of the upper arm 111 is referred to as the surface layer portion 134. In addition, a portion of the adjacent portion 140 that is located inside the surface layer portion 134 is referred to as a deep layer portion 132. The material that forms the surface layer portion 134 and the deep layer portion 132 of the adjacent portion 140 is the same as the material that forms the deep layer portion 202 of the fuse portion 150 (such as Al).

In the electric power conversion apparatus 40 of the present embodiment, the magnetic permeability of the material that forms the surface layer portion 204 of the fuse portion 150 is lower than the magnetic permeability of the material that forms the surface layer portion 134 of the adjacent portion 140. In other words, the magnetic permeability of the material that is located on the surface of the fuse portion 150 is lower than the magnetic permeability of the material that is located on the surface of the adjacent portion 140. Thus, the parasitic inductance that occurs in the fuse portion 150 can be reduced in comparison with a case where the magnetic permeability of the material that is located on the surface of the fuse portion 150 is the same as the magnetic permeability of the material that is located on the surface of the adjacent portion 140. Accordingly, the inductance of the upper arm 111 can be reduced.

A method of manufacturing the fuse portion 150 and the adjacent portion 140 of the present embodiment will be described next. First, the adjacent portion 140 that is located on an upper side in FIG. 4 and the adjacent portion 140 that is located on a lower side in FIG. 4 are formed of aluminum. Then, the adjacent portion 140 that is located on an upper side in FIG. 4 and the adjacent portion 140 that is located on a lower side in FIG. 4 are electrically connected to each other with a copper clad aluminum wire (CCAW). In other words, one end of the copper clad aluminum wire is joined to the adjacent portion 140 on the upper side in FIG. 4, and the other end of the copper clad aluminum wire is joined to the adjacent portion 140 on the lower side in FIG. 4. A portion that is formed of the copper clad aluminum wire functions as the fuse portion 150.

### Third Embodiment

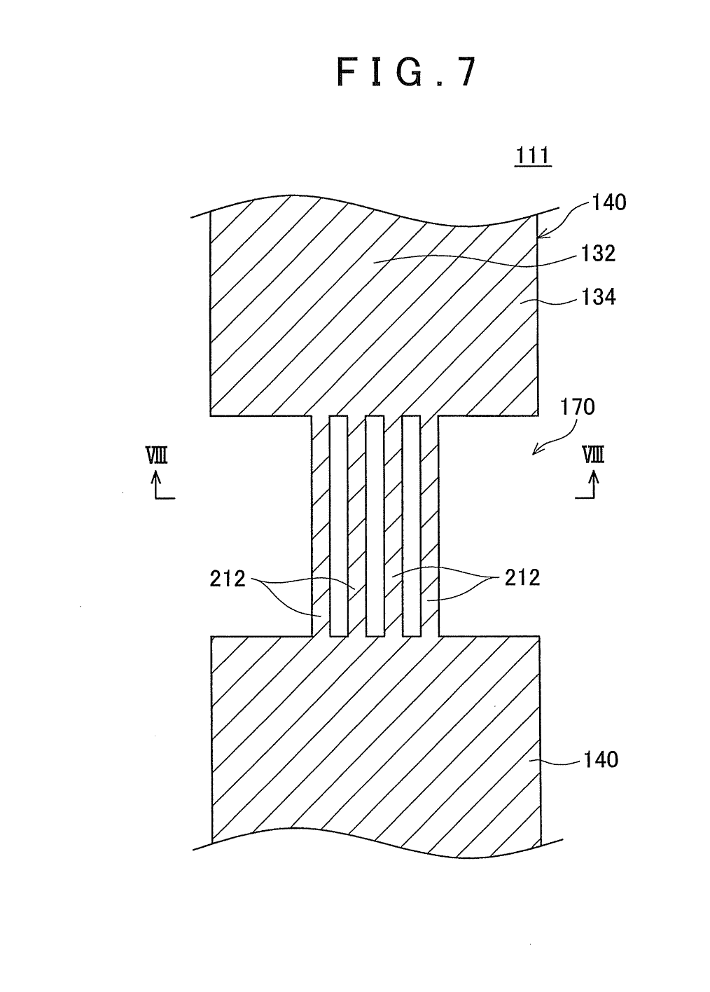

The adjacent portion 140 of a third embodiment has an identical structure with the adjacent portion 140 of the second embodiment. In other words, the entire cross-section of the adjacent portion 140 is formed of a single material as shown in FIG. 7.

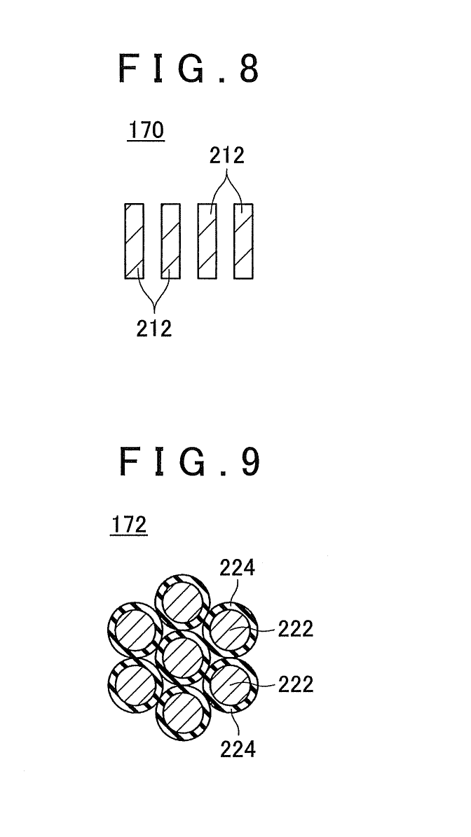

A fuse portion 170 of the third embodiment includes a plurality of fine wires 212 that have a minute cross-sectional area as shown in FIGS. 7 and 8. The adjacent portion 140 and the fuse portion 170 are formed of the material that has electrical conductivity. As the material that forms the adjacent portion 140 and the fuse portion 170, aluminum can be used, for example. One end of each fine wire 212 is connected to the adjacent portion 140 on the upper side in FIG. 7, and the other end of each fine wire 212 is connected to the adjacent portion 140 on the lower side in FIG. 7. Each of the plurality of fine wires 212 electrically connects between the adjacent portion 140 on the upper side in FIG. 7 and the adjacent portion 140 on the lower side in FIG. 7. That is, the plurality of fine wires 212 form current-carrying paths in parallel with each other. As shown in FIG. 8, the plurality of fine wires 212 are arranged in a row in a longitudinal direction of FIG. 8. The plurality of fine wires 212 are spaced a portion from each other. The surface of each fine wire 212 is coated with electrical insulating varnish (not shown). In other words, the fine wires 212 are insulated from each other.

When the skin effect occurs in the fuse portion 170, much electric current flows in the surface layer portion of the fuse portion 170 (a total surface layer portion of the fine wires 212). As described above, the fuse portion 170 is constructed with the plurality of fine wires 212. The surface area per unit length of the current-carrying path for the fuse portion 170 (the total surface area of the fine wires 212) is designed to be larger than the surface area per unit length of the current-carrying path for the adjacent portion 140. Therefore, when the skin effect occurs in the fuse portion 170, the density of the current flowing in the surface layer portion of the fuse portion 170 can be reduced. Thus, the parasitic inductance that occurs in the fuse portion 170 can be reduced. Accordingly, the inductance of the upper arm 111 can be reduced.

A method of manufacturing the fuse portion 170 and the adjacent portion 140 of the present embodiment will be described. First, the adjacent portion 140 on the upper side in FIG. 7 and the adjacent portion 140 on the lower side in FIG. 7 are formed of aluminum. Then, the adjacent portion 140 on the upper side in FIG. 7 and the adjacent portion 140 on the lower side in FIG. 7 are electrically connected to each other with a plurality of fine Al wires. In other words, one end of each of the plurality of fine Al wires is joined to the adjacent portion 140 on the upper side in FIG. 7, and the other end is joined to the adjacent portion 140 on the lower side in FIG. 7. Each of the plurality of fine Al wires functions as the fine wire 212. A portion that is constructed by the plurality of fine wires 212 functions as the fuse portion 170.

The fuse portion 170 and the adjacent portion 140 of the present embodiment can be formed by cutting an Al wire. That is a portion of the Al wire that functions as the fuse portion 170 is cut. By the cutting, the material in a portion other than that functioning as the plurality of fine wires 212 is removed from the portion functioning as the fuse portion 170. Accordingly, the portion remaining after the removal of the material in the portion functioning as the fuse portion 170 functions as the plurality of fine wires 212. A portion that is constructed by the plurality of fine wires 212 in the Al wire functions as the fuse portion 170. In addition, the portion adjacent to the fuse portion 170 in the Al wire functions as the adjacent portion 140.

The fuse portion 170 and the adjacent portion 140 of the present embodiment can be manufactured by etching. By the etching, the material in a portion other than that functioning as the plurality of fine wires 212 is removed from the portion functioning as the fuse portion 170. Accordingly, the portion remaining after the removal of the material in the portion functioning as the fuse portion 170 functions as the plurality of fine wires 212. In addition, the portion adjacent to the fuse portion 170 in the Al wire functions as the adjacent portion 140.

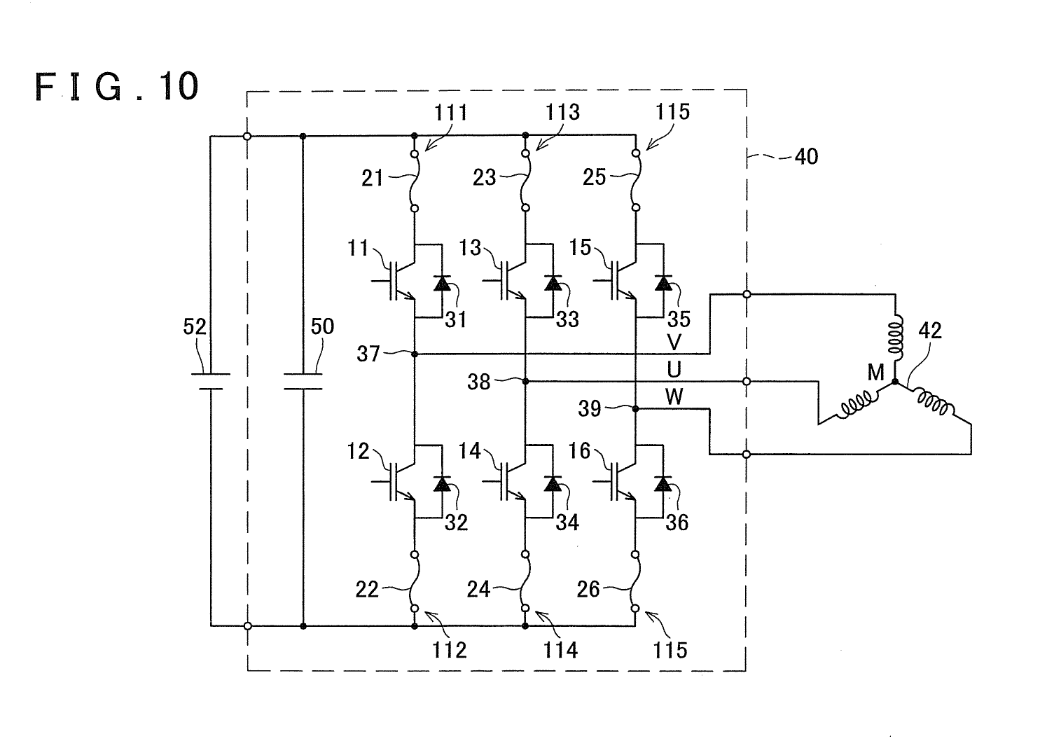

As shown in FIG. 9, a cross-sectional shape of a fine wire 222 in the other form of the third embodiment is a circle. The plurality of fine wires 222 are arranged in a longitudinal direction of FIG. 9 and in a vertical direction of FIG. 9 as well. A circumference of each fine wire 222 is coated with electrical insulating varnish 224. It should be noted that the cross-sectional shape of the fine wire 222 may be any shapes other than the circle. For example, the cross-sectional shape of the fine wire 222 may be a hexagon.

In the embodiments described above, the electric power conversion apparatus 40 was an inverter. However, the electric power conversion apparatus 40 may be other apparatus that convert between AC power and DC power. The electric power conversion apparatus 40 may be a converter, for example.

While the present invention has been described in detail with reference to example embodiments thereof, it is to be understood that those examples are merely illustrative and claims of the present invention are not limited to those examples. Techniques that are disclosed in the claims of the present invention are intended to cover various modifications and changes of the example embodiments that are described above. In addition, the technical elements that are described in this specification and the drawings demonstrate technical utility when used singly or in various combinations. The techniques that are illustrated in the specification and the drawings can achieve a plurality of objects simultaneously, and the achievement of one object thereof itself has technical usefulness.

What is claimed is:

1. An electric power conversion apparatus comprising:
an electric power conversion portion that switches on and off a power device and converts between AC power and DC power;
an adjacent portion that is connected to a terminal of the power device; and
a fuse portion that is adjacent to the adjacent portion, in which a cross-sectional area of the fuse portion is smaller than that of the adjacent portion, and in which a magnetic flux density generated in the fuse portion is smaller than a magnetic flux density generated in the adjacent portion when a structure of the fuse portion is made identical with that of the adjacent portion.

2. The electric power conversion apparatus according to claim 1, wherein
a surface area per unit length of the fuse portion is larger than a surface area per unit length of the adjacent portion.

3. The electric power conversion apparatus according to claim 1, wherein
magnetic permeability of a material that is located on a surface of the fuse portion is lower than magnetic permeability of a material that is located on a surface of the adjacent portion.

4. A current-carrying device that carries AC power, comprising:
an adjacent portion in which the AC power is input from or output to an external device; and
a fuse portion that is adjacent to the adjacent portion, in which a cross-sectional area of the fuse portion is smaller than that of the adjacent portion, and in which a magnetic flux density generated in the fuse portion is smaller than a magnetic flux density generated in the adjacent portion when a structure of the fuse portion is made identical with that of the adjacent portion.

5. The current-carrying device that carries AC power according to claim 4, wherein
a surface area per unit length of the fuse portion is larger than a surface area per unit length of the adjacent portion.

6. The current-carrying device that carries AC power according to claim 4, wherein
magnetic permeability of a material that is located on a surface of the fuse portion is lower than the magnetic permeability of a material that is located on a surface of the adjacent portion.

7. A method of manufacturing a current-carrying device that carries AC power, comprising:
forming a cross-sectional area of a fuse portion that is adjacent to an adjacent portion to be smaller than that of the adjacent portion, the adjacent portion in which the AC power is input from or output to an external device; and
forming an adjustment portion so that a magnetic flux density generated in the fuse portion to be smaller than a magnetic flux density generated in the adjacent portion when a structure of the fuse portion is made identical with that of the adjacent portion.

8. The method of manufacturing a current-carrying device that carries AC power according to claim 7, wherein
the forming the adjustment portion includes a forming a surface area per unit length of the fuse portion to be larger than that of the adjacent portion.

9. The method of manufacturing a current-carrying device that carries AC power according to claim 7, wherein
the forming the adjustment portion includes an arranging a material on a surface of the adjacent portion, a magnetic permeability of the material is larger than that of a material located on a surface of the fuse portion.

10. The method of manufacturing a current-carrying device that carries AC power according to claim 7, wherein
the forming the adjustment portion includes an arranging a material on a surface of the fuse portion, a magnetic permeability of the material is smaller than that of a material located on a surface of the adjacent portion.
